(19) United States
(12) Patent Application Publication
(10) Pub. No.: US 2006/0244286 A1
(43) Pub. Date: Nov. 2, 2006

(54) Resilient wedge for a vehicle door wedge assembly

(76) Inventors: Jason A. Meyers, Shelby Twp., MI (US); Gary L. Schubring, Chesterfield, MI (US)

Correspondence Address: HARNESS, DICKEY & PIERCE, P.L.C., P.O. BOX 828, BLOOMFIELD HILLS, MI, 48303, US

(21) Appl. No.: 11/410,845

(22) Filed: Apr. 25, 2006

Related U.S. Application Data
(60) Provisional application No. 60/676,908, filed on May 2, 2005.

(51) Int. Cl. B60J 5/00

(52) U.S. Cl. 296/146.1

(57) ABSTRACT

A vehicle door resilient wedge system includes a resilient wedge body coupled to a receiving element. The body includes engagement and second surfaces, and opposed convex ends integrally joining the surfaces. Inwardly extending portions of both surfaces create internal body cavities. A passageway interconnects the cavities which permits wedge elastic deflection.

### CROSS-REFERENCE TO RELATED APPLICATIONS

This application claims the benefit of U.S. Provisional Application No. 60/676,908, filed on May 2, 2005. The disclosure of the above application is incorporated herein by reference.

### TECHNICAL FIELD

The present disclosure relates in general to vehicle door displacement and anti-chucking devices and more specifically to a resilient wedge device and method for assembling a vehicle door resilient wedge device.

### BACKGROUND

Vehicles including automobile sport utility vehicles, station wagons, mini-vans, cross-over vehicles, cargo vans and trucks often provide an access door, commonly known as a lift-gate door. Other similar door designs include hatchback doors, sliding doors and horizontally swinging doors. Although these door designs can be mounted differently, for simplicity, these door designs will hereinafter be summarized in reference to lift-gate doors. Lift-gate doors are frequently hinged along an upper horizontal surface, and latch adjacent to a flooring system of the automobile, commonly adjacent to the rear fender of the automobile. One or more latches can be used. The side edges of lift-gate doors are generally not hinged or physically connected to the vehicle structure or support posts at the rear of the vehicle. Motion of the vehicle therefore can result in “match-boxing”, or non-parallel deflection of the support posts relative to the squared sides of the lift-gate door. Match-boxing is undesirable for several reasons. First, side-to-side or non-parallel motion of support posts can impart additional vehicle noise, known as “chucking” at the lift-gate latch as the vehicle travels along rough or uneven surfaces. Second, unless a mechanism is positioned between the lift-gate door edge and the support posts of the vehicle, full structural allowance for the stiffness of the lift-gate cannot be used in the design of the support structure area.

In order to include the stiffness of the lift-gate door in the analysis and design of structural support posts, relatively rigid normally plastic wedge assemblies having movable slides have been used which displace to span the gap between the lift-gate door and the support post. These assemblies reduce match-box deflection of the support posts by transferring some deflection load to the lift-gate door using wedge assemblies generally positioned between each support post and the lift-gate door. The wedge assembly can be fastened to either or both edges of the lift-gate door or to an edge of one or both of the support posts. In a further known design, a slide assembly is positioned against each lift-gate door side edge and a striker plate is separately mounted to each support post such that the slide engages the striker plate to limit match-boxing of the support posts.

Common designs for wedge assemblies have several problems. First, vehicle raffling noise is produced if the slide is not maintained in continuous contact with the striker plate (or vehicle support post) throughout the travel length of the slide. Tolerances used for common wedge assembly slides permit easy translation, but can result in rattling between the parts during vehicle travel. Second, vehicle manufacturing tolerances can result in positions of non-contact between the slide and the striker plate (or vehicle support post). If the slide is not maintained in contact with the vehicle support post or striker plate, rattling can occur. Third, contaminants such as dirt which contact portions of the wedge assembly can prevent the slide from moving freely, thus resulting in increased chucking or rattling noise.

### SUMMARY

According to one embodiment of a resilient wedge for a vehicle door wedge assembly of the present disclosure, the hard plastic wedge of known wedge systems is replaced with a resilient wedge system including a body having an engagement surface with a first extending portion directed inwardly with respect to the body from the engagement surface. A second surface is opposed to the engagement surface, the second surface is oriented at an angle with respect to the engagement surface. The second surface includes a second extending portion directed inwardly from the second surface and toward the first extending portion. Opposed ends integrally join the engagement surface to the second surface. The first and second extending portions define opposed internal cavities of the body. The internal cavities are interconnected by a passageway positioned between the first and second extending portions. The passageway is narrower than the internal cavities and permits elastic deflection of the first extending portion toward the second extending portion.

According to another aspect of the disclosure, a vehicle door resilient wedge system includes a receiving element having a mating face and a receiving ramp positioned opposite to the mating face. The receiving ramp continuously slopes further away from the mating face between a ramp first end and a ramp second end. An elastically deflectable wedge body engageable with the receiving element in an installed condition includes an engagement surface slidingly received by the receiving ramp. A second surface is opposed to the engagement surface. The second surface is oriented at an angle with respect to the engagement surface. Opposed ends integrally join the engagement surface to the second surface.

According to yet another aspect of the disclosure, a method for assembling a vehicle door wedge assembly is provided. According to yet still another aspect, a method for creating an elastically deformable wedge for a vehicle door-to-body engagement system is provided.

A resilient wedge of the present disclosure offers several advantages. By replacing the rigid plastic wedge of common anti-chucking wedge assemblies with a slide-in resilient wedge capable of elastic deformation of the present disclosure, a noise transmission path through the wedge assembly is at least partially attenuated. The resilient wedge also limits match-boxing by its capability to elastically deflect while maintaining continuous contact with either the vehicle door or structural post of the vehicle. The resilient wedge of the present disclosure is a one-piece element which therefore does not require a separate biasing device such as a spring to permit its deflection, which reduces complexity and costs of the design. A one piece resilient wedge of a thermo-plastic or polymeric material also is resistant to the detrimental affects from exposure to moisture and/or dirt.

Further areas of applicability of the present disclosure will become apparent from the detailed description provided hereinafter. It should be understood that the detailed description and specific examples, while indicating several embodiments of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a rear elevational view of a vehicle having resilient wedge assemblies of the present disclosure;

FIG. 2 is a front perspective view of a resilient wedge of the present disclosure installed in an exemplary wedge assembly;

FIG. 3 is a side elevational view of the resilient wedge of FIG. 2;

FIG. 4 is an end elevational view of the resilient wedge of FIG. 2;

FIG. 5 is a top plan view of the resilient wedge of FIG. 2;

FIG. 6 is a front perspective view of an exemplary wedge assembly body;

FIG. 7 is an elevational perspective view showing a typical installation of a resilient wedge assembly of the present disclosure into a door frame of a vehicle;

FIG. 8 is a side elevational view of another embodiment of the resilient wedge of FIG. 2;

FIG. 9 is a plan view of the resilient wedge of FIG. 8 taken at view 9-9 of FIG. 8;

FIG. 10 is a cross sectional end elevational view taken at section 10-10 of FIG. 8; and

FIG. 11 is a side elevational view of yet another embodiment of the resilient wedge of FIG. 2.

### DETAILED DESCRIPTION

The following description of several embodiments is merely exemplary in nature and is in no way intended to limit the disclosure, its application, or uses.

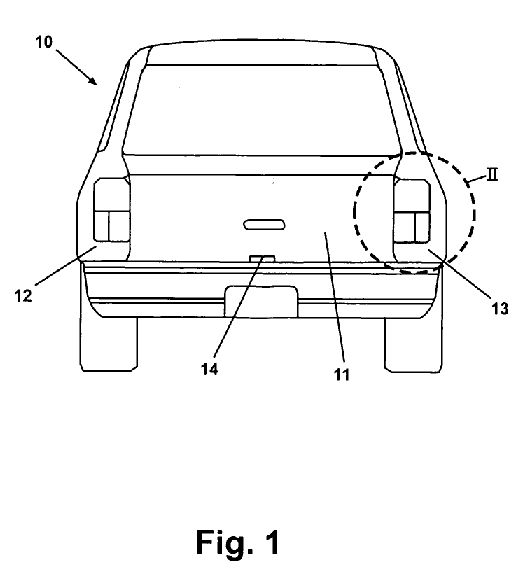

Referring generally to FIG. 1, a vehicle 10 includes a rear lift-gate door 11 positioned between both a left support post 12 and a right support post 13 of vehicle 10. A latch 14 is generally provided about mid span along a bottom edge of rear lift-gate door 11. Side edges of rear lift-gate door 11 adjacent to left support post 12 and right support post 13, respectively, are generally not latched or otherwise connectable to left support post 12 or right support post 13.

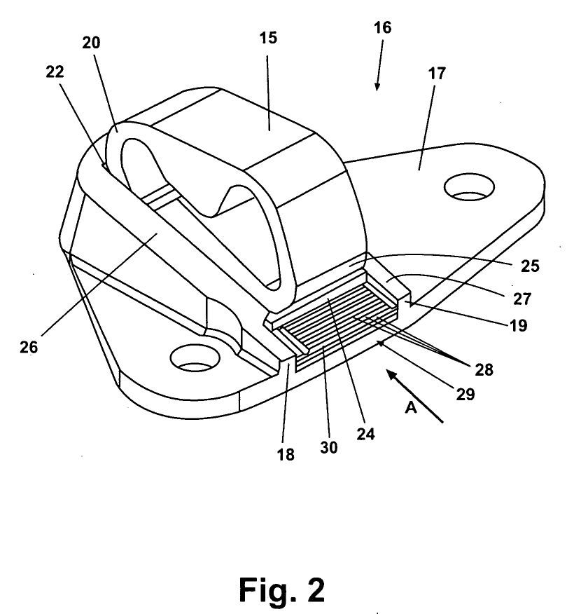

According to one aspect of a resilient wedge for an anti-chucking wedge assembly of the present disclosure, and referring generally to FIG. 2, a resilient wedge 15 of an elastomeric material such as, but not limited to a thermo-plastic elastomer, rubber, neoprene, silicon rubber, a block copolymer material, or other elastically deformable polymeric material(s) is connected to a wedge support member 17. Resilient wedge 15 is slidably received in the direction of installation arrow “A” between first and second channel walls 18 and 19 to engage resilient wedge 15 with support member 17 in the engaged position shown. A first end 20 of resilient wedge 15 abuts a contact wall 22 of support member 17 in the engaged position. An engagement member 24 extending outwardly from a second end 25 of resilient wedge 15 is partially received by opposing first and second flanges 26, 27 of support member 17. To retain resilient wedge 15 in the engaged position, engagement member 24 contacts one of a plurality of raised ribs 28. Raised ribs 28 are created on a ramp 30 of support member 17 and are positioned substantially parallel to and substantially equidistantly spaced with respect to each other. Ramp 30 slopes upwardly (as viewed in FIG. 2) from an end face 29 of support member 17 continuously toward contact wall 22.

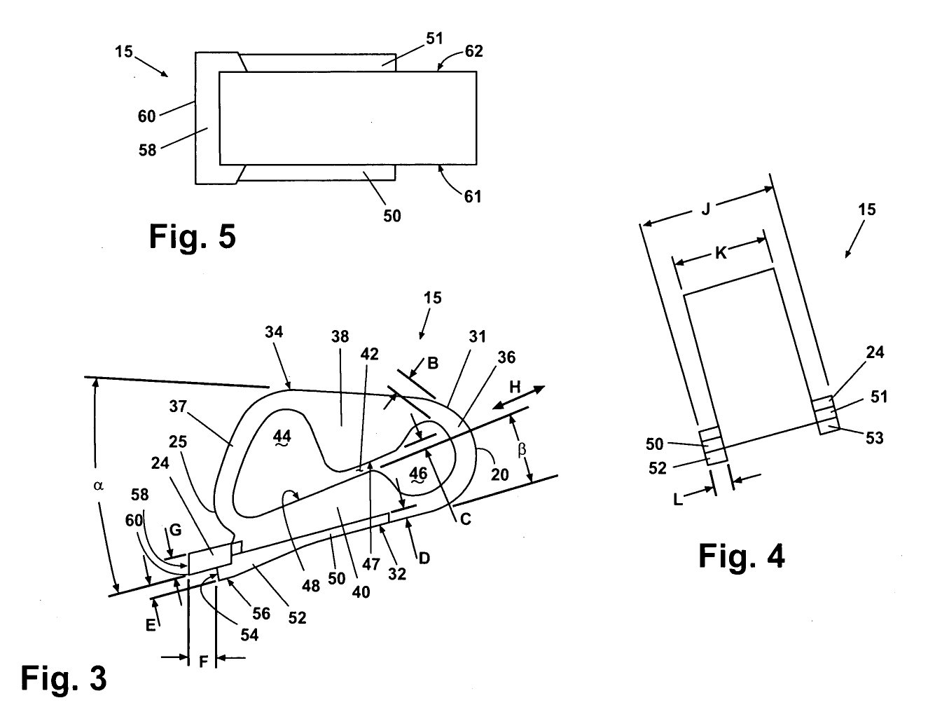

Referring now generally to FIGS. 3 through 5, resilient wedge 15 includes a body 31 having an engagement surface 32 and an oppositely positioned second or exposed surface 34. Second surface 34 is oriented at an angle α with respect to engagement surface 32. According to one aspect of the present disclosure, angle α is approximately 19.6°. Wedge first end 20 includes a first wall 36, and second end 25 includes a second wall 37. In several aspects of the present disclosure, each of first wall and second wall 36, 37 have a wall thickness “B” of approximately 3.0 mm.

A first extending portion 38 extends inwardly from second surface 34. A second extending portion 40 extends inwardly from engagement surface 32 and generally toward first extending portion 38. A passageway 42 is defined between distal ends of each of first and second extending portions 38, 40. In one aspect of the disclosure, passageway 42 has a passageway opening depth “C” of approximately 1.5 mm. First and second extending portions 38, 40 together define each of a first internal cavity 44 and a second internal cavity 46 having passageway 42 in open communication between them. First and second walls 36, 37 are preferably created having a convex shape curving outwardly with respect to first and second internal cavities 44, 46. The convex shape of first and second walls 36, 37 permit elastic displacement of first extending portion 38 towards second extending portion 40 until a first contact face 47 of first extending portion 38 contacts a second contact face 48 of second extending portion 40. Following elastic deformation, second surface 34 returns elastically to the general position shown in FIG. 3.

Second contact face 48 is oriented at an angle β with respect to engagement surface 32. First contact face 47 is oriented substantially parallel to second contact face 48. This geometry of first and second contact faces 47, 48 also permits first extending portion 38 to displace in the direction of displacement arrows “H” either before or after contact between first and second contact faces 47, 48.

First and second flanges 50, 51 extend outwardly from a first and a second side 61, 62 of body 31. The purpose of first and second flanges 50, 51 is to provide additional engagement of resilient wedge 15 with each of first and second flanges 26, 27 of wedge support member 17. First flange 50 further includes a first tapering portion 52 and second flange 51 correspondingly includes a second tapering portion 53. Each of first and second tapering portions 52, 53 have a distal end face 54 proximate to a distal surface 56. First and second tapering portions 52, 53 also help support engagement member 24. Engagement member 24 further includes an engagement member face 58 and an outer corner 60 which substantially aligns with end face 29 when resilient wedge 15 is fully installed on wedge support member 17.

In one aspect of the present disclosure, end face 54 has a face height “E” of approximately 2.0 mm. Engagement member 24 extends beyond end face 54 by an extension length “F” of approximately 4.3 mm. An engagement member face height “G” is approximately 3.5 mm. A total engagement member width “J” is approximately 21.4 mm and a body width “K” is approximately 15.1 mm. Each of first and second tapering portions 52, 53 have an individual flange element width “L” of approximately 3.2 mm. According to this aspect of the present disclosure, contact face angle β is approximately 7°.

First and second flanges 50, 51 extend outwardly as noted from each of first and second sides 61, 62 and extend longitudinally approximately two-thirds of a total length of body 31. The length of extension of first and second flanges 50, 51 can be varied by the designer without departing from the scope of the present disclosure. The shape of each of first and second internal cavities 44, 46 and passageway 42 can also vary from that shown herein without departing from the scope of the present disclosure.

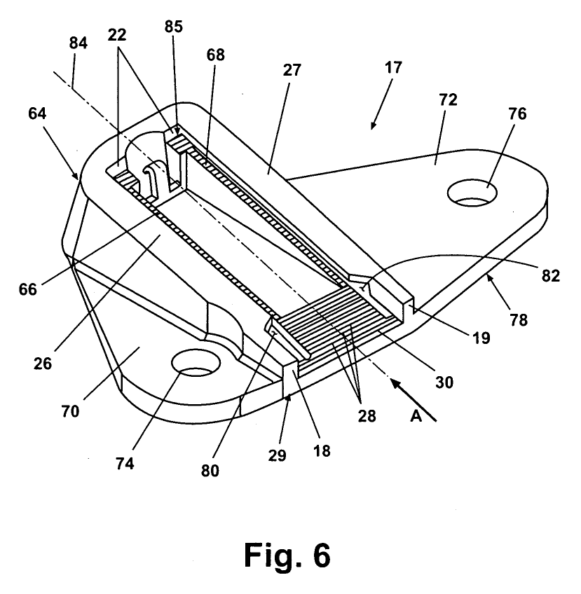

As best seen in reference to FIG. 6, wedge support member 17 according to one aspect of the disclosure includes a support member end face 64. Ramp 30 is divided into each of a first ramp extension 66 and a second ramp extension 68. The plurality of raised ribs 28 continue along each of first and second ramp extensions 66, 68. Wedge support member 17 further includes a first wing member 70 and a second wing member 72. A first clearance aperture 74 is positioned in first wing member 70 and a second clearance aperture 76 is positioned in second wing member 72. A contact face 78 is provided to engage wedge support member 17 with a surface of vehicle 10.

Wedge support member 17 further includes a first clearance gap 80 proximate to and running substantially parallel with first flange 26. Similarly, a second clearance gap 82 is positioned proximate to and running substantially parallel to second flange 27. First and second flanges 50, 51 and engagement member 24 are slidably received within each of first and second clearance gaps 80, 82 when resilient wedge 15 is slidably engaged in installation direction “A”. First and second ramp extensions 66, 68 are each substantially equally spaced from a ramp longitudinal axis 84. Each of first and second ramp extensions 66, 68 end at a ramp second end 85 defining contact wall 22. In the aspect shown in FIG. 6, first wing member 70 is substantially smaller than second wing member 72. First and second wing members 70, 72 can also be substantially equally sized or first wing member 70 can be larger than second wing member 72. By changing the geometry of first or second wing members 70, 72 a right hand or left hand configuration of wedge support member 17 can be provided. The disclosure is therefore not limited to the geometry of wedge support member 17 shown but can be used for a plurality of geometries of wedge support member 17.

Resilient wedge 15 is intended to replace the sliding hard plastic wedges of previous anti-chucking wedge assemblies. For example, resilient wedge 15 of the present disclosure can be used to replace slide element 14 and spring element 18 in the assembly identified in U.S. Pat. No. 4,932,100 issued to Flowers et al. on Jun. 12, 1990, which is commonly owned by the assignee of the present disclosure.

For simplicity, discussion of the present disclosure refers in general to resilient wedge assemblies 16 connected to right support post 13. Wedge assemblies 16 of the present disclosure are not limited to specific installation locations, and can be connected to left support post 12 or other component parts including the sides, top, or bottom of rear lift-gate door 11 of vehicle 10 or to similar door or door support structure of vehicle 10. A striker (not shown) can be mounted opposite to resilient wedge 15 on the directly opposing vehicle component to contact resilient wedge 15, or resilient wedge 15 can directly contact the surface of the directly opposing vehicle component. Wedge assemblies 16 of the present disclosure can be “non-handed” for general interchangeable use or can be configured in “left hand” and/or “right hand” configurations at the discretion of the designer.

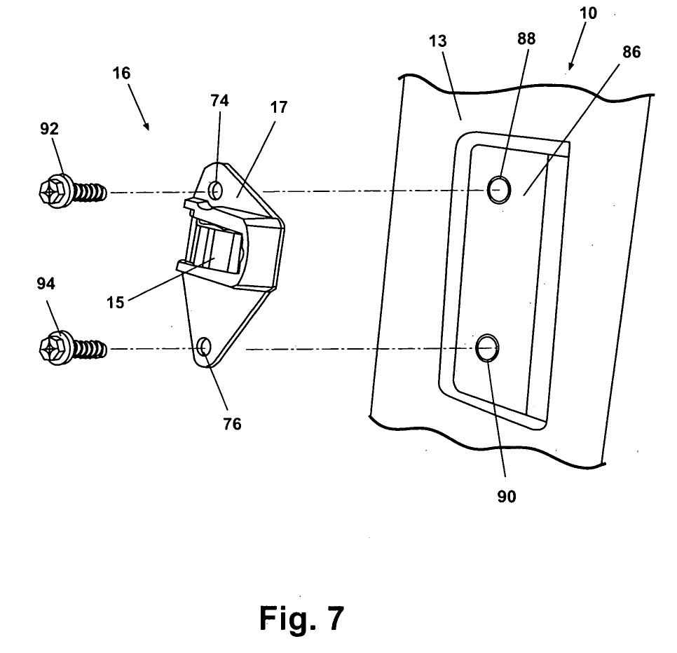

Referring now to FIG. 7, an exemplary installation of resilient wedge assembly 16 abuts wedge support member 17 against a receiving area 86 of right support post 13 with resilient wedge 15 oriented away from right support post 13. Receiving area 86 is shown as a stamped or recessed area prelocated on right support post 13, but can be any suitable surface. Receiving area 86 includes each of a first and a second fastener engagement aperture 88, 90. A pair of fasteners 92 and 94 of metal or other known material, including screws, self-tapping screws, self-tapping bolts, or the like are inserted through each of first clearance aperture 74 and second clearance aperture 76, respectively, to threadably engage with first and second fastener engagement apertures 88, 90. Pre-installed or pre-molded nuts (not shown) can also be used in place of the engagement apertures.

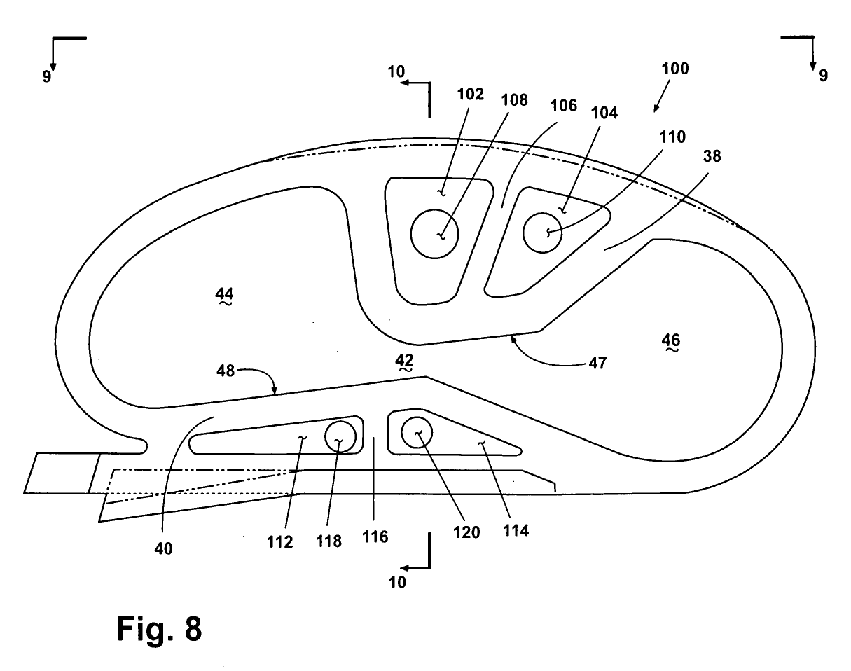

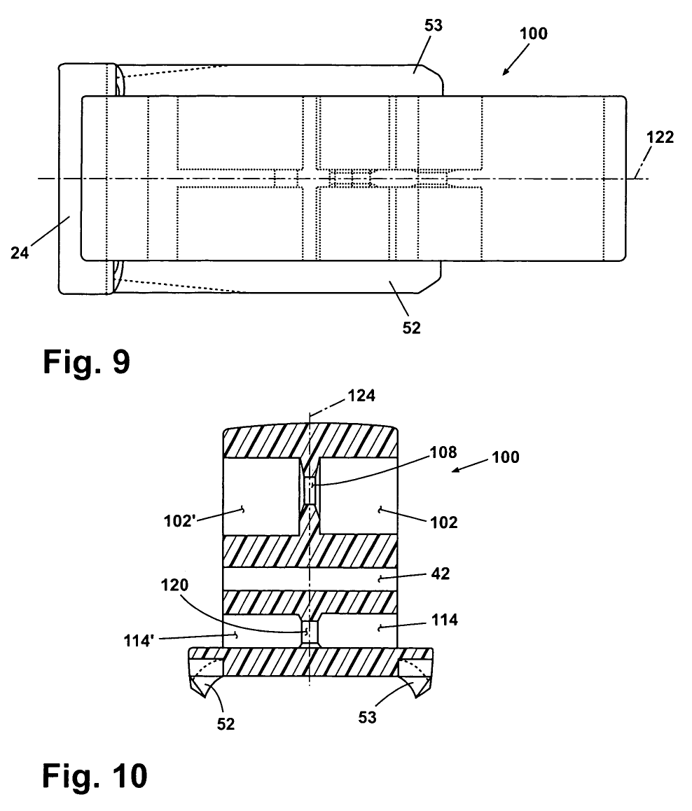

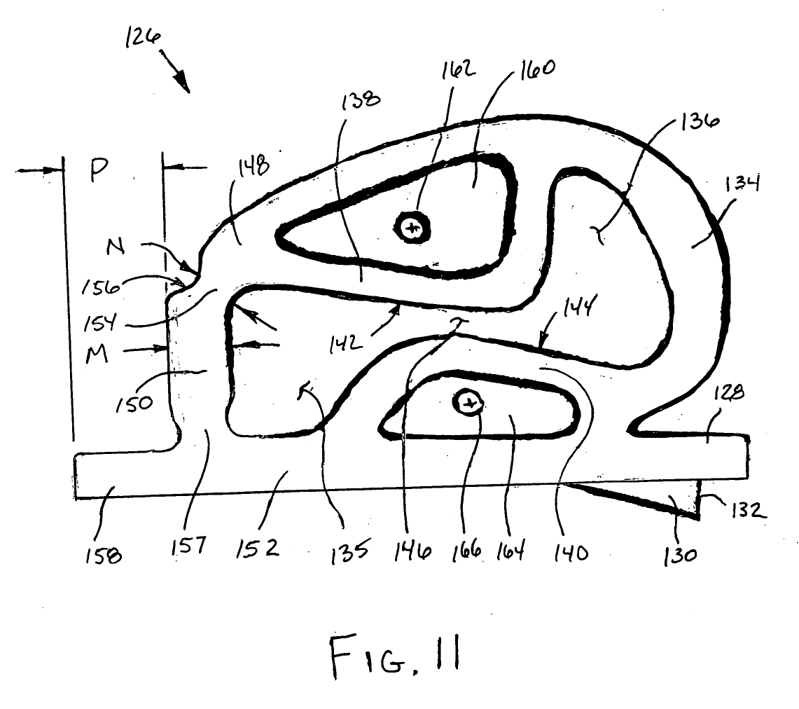

Referring now to FIGS. 8 through 10, a resilient wedge 100 is modified from resilient wedge 15 to reduce part shrinkage during molding and to provide for moisture drainage to prevent freezing during cold weather application. First extending portion 38 can be modified to include first and second opposed partial cavity pairs 102, 102′ and 104, 104′. First and second opposed partial cavity pairs 102, 102′ and 104, 104′ are separated by a common wall 106 and act to remove material from first extending portion 38 to reduce part shrinkage during production of resilient wedge 100. Because first and second opposed partial cavity pairs 102, 102′ and 104, 104′ are used, a first through aperture 108 joining first opposed partial cavity pairs 102, 102′ is provided and a second through aperture 110 joins second opposed partial cavity pairs 104, 104′. First and second through apertures 108, 110 help drain fluid which may be present in any of first and second opposed partial cavity pairs 102, 102′ and 104, 104′ to prevent the fluid from freezing during cold weather conditions of operation.

Second extending portion 40 is similarly provided with third and fourth opposed partial cavity pairs 112, 112′ and 114, 114′ and third and fourth through apertures 118, 120 respectively, which serve the same functions as noted above. A second common wall 116 separates third and fourth opposed partial cavity pairs 112, 112′ and 114, 114′. First and second opposed partial cavity pairs 102, 102′ and 104, 104′, and third and fourth opposed partial cavity pairs 112, 112′ and 114, 114′ are substantially oppositely positioned with respect to a resilient wedge longitudinal axis 122, and a resilient wedge vertical axis 124.

A depth and size of each of first and second opposed partial cavity pairs 102, 102′ and 104, 104′, as well as third and fourth opposed partial cavity pairs 112, 112′, and 114, 114′ can also be controlled. This depth and size control helps predetermine the amount of deflection or compression that each of first and second extending portions 38, 40 can accept when first contact face 47 contacts second contact face 48. The geometry of first and second extending portions 38, 40 can also be modified to predetermine the amount of deflection or compression that each of first and second extending portions 38, 40 can accept.

Referring now to FIG. 11, in several embodiments a resilient wedge 126 is modified from resilient wedge 100. Resilient wedge 126 includes an engagement member 128 having a tapering portion 130 extending therefrom. Tapering portion 130 includes an end face 132. A curved outer wall 134 encloses first and second internal through cavities 135, 136. An inner first wall 138 and an inner second wall 140 define first and second contact faces 142, 144 between which a passageway 146 opens between the first and second through cavities 135, 136. A junction area 148 is created between outer wall 134, first wall 138 and a column portion 150. Column portion 150 is oriented at an angle to a base wall 152 and includes a column thickness “M”. A neck region 154 is created between column portion 150 and junction area 148 by a curved surface 156. A neck region wall thickness “N” is smaller than column thickness “M”, therefore permitting neck region 154 to deflect relative to column 150. A neck region 157 similar to neck region 154 can also be created between column portion 150 and an extending portion 158. The extending portion 158 is an extension of base wall 152 and extends away from column 150 by a dimension “P”. Similar to resilient wedge 100, resilient wedge 126 can include a first partial cavity 160 having a through aperture 162 and a second partial cavity 164 with a through aperture 166.

A resilient wedge of the present disclosure offers several advantages. By replacing the rigid plastic wedge of common anti-chucking wedge assemblies with a slide-in resilient wedge of the present disclosure capable of elastic deformation, a noise transmission path through the wedge assembly is at least partially attenuated. The resilient wedge also limits match-boxing by its capability to elastically deflect while maintaining continuous contact with either the vehicle door or structural post of the vehicle. The resilient wedge of the present disclosure is a one-piece element which therefore does not require a separate biasing device such as a spring to permit its deflection, which reduces complexity and costs of the assembly. A one piece resilient wedge of a thermo-plastic or polymeric material also is resistant to the detrimental affects from exposure to moisture and/or dirt.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A vehicle door resilient wedge system, comprising:
an elastically deflectable body including:
an engagement surface having a first extending portion directed inwardly with respect to the body from the engagement surface;
a second surface opposed to the engagement surface, the second surface oriented at an angle with respect to the engagement surface, the second surface including a second extending portion directed inwardly from the second surface and toward the first extending portion; and
opposed ends integrally joining the engagement surface to the second surface;
wherein each of the first and second extending portions includes an internal cavity, the internal cavities being interconnected by a passageway positioned between the first and second extending portions, the passageway being narrower than the internal cavities to permit elastic deflection of the first extending portion toward the second extending portion.

2. The resilient wedge of claim 1, wherein the body further comprises a polymeric material.

3. The resilient wedge of claim 2, wherein the polymeric material further comprises a thermoplastic elastomer material operable to allow elastic displacement of the extending portions between a non-deflected condition and a contact position of the extending portions proximate the passageway.

4. The resilient wedge of claim 3, wherein the thermoplastic elastomer material further comprises a rubber material.

5. The resilient wedge of claim 1, further comprising an engagement member extending outwardly from a first one of the opposed ends.

6. The resilient wedge of claim 5, wherein each of the opposed ends define a convex-shape.

7. The resilient wedge of claim 1, further comprising opposed first and second partial cavity pairs created in the first extending portion.

8. The resilient wedge of claim 7, further comprising:
a first through aperture communicably joining the first partial cavity pair; and
a second through aperture communicably joining the second partial cavity pair.

9. The resilient wedge of claim 8, further comprising opposed third and fourth partial cavity pairs created in the second extending portion.

10. The resilient wedge of claim 9, further comprising:
a third through aperture communicably joining the third partial cavity pair; and
a fourth through aperture communicably joining the fourth partial cavity pair.

11. The resilient wedge of claim 1, wherein the body further comprises:
opposed substantially parallel sides, the sides being substantially perpendicular to the opposed ends; and
opposed flange members each extending outwardly from one of the opposed sides.

12. The resilient wedge of claim 1, wherein a wall thickness of both of the opposed ends is substantially equal.

13. The resilient wedge of claim 1, further comprising:
a column portion of one of the ends extending substantially perpendicular to the engagement surface;
an outer wall connecting the ends; and
at least one neck region having a wall thickness less than a column portion wall thickness, the neck region connecting the column portion to one of the outer wall and the engagement surface.

14. A vehicle door resilient wedge system, comprising:
a receiving element;
a body slidably engageable with the receiving element, the body including:
an engagement surface;
a second surface opposed to the engagement surface, the second surface oriented at an angle with respect to the engagement surface; and
opposed ends integrally joining the engagement surface to the second surface;
a first extending portion directed inwardly from the engagement surface; and
a second extending portion directed inwardly from the second surface and toward the first extending portion;
wherein the first and second extending portions internally divide the body and operably define opposed internal cavities of the body, the internal cavities being interconnected by a passageway narrower than the internal cavities.

15. The resilient wedge system of claim 14, wherein the receiving element further comprises:
a mating face; and
a receiving ramp positioned opposite to the mating face, the receiving ramp continuously sloping further away from the mating face between a ramp first end and a ramp second end.

16. The resilient wedge system of claim 15, wherein the receiving ramp further comprises a plurality of substantially parallel raised ribs each extending substantially perpendicular to a longitudinal axis of the receiving ramp.

17. The resilient wedge system of claim 16, wherein the body further comprises opposed substantially parallel sides, the sides being substantially perpendicular to the opposed ends.

18. The resilient wedge system of claim 17, wherein the body further comprises opposed first and second flanges each extending outwardly from one of the opposed sides, the first and second flanges operable to resist release of the body from an installed condition with the receiving element.

19. The resilient wedge system of claim 18, wherein the receiving member further comprises opposed raised flanges each operable to slidingly engage one of the opposed flanges of the body.

20. The resilient wedge system of claim 19, wherein each of the raised flanges further comprises a post end wherein a second one of the opposed ends of the body is slidingly receivable between the post ends of the raised flanges at the ramp first end.

21. A vehicle door resilient wedge system, comprising;
a receiving element, including;
a mating face; and
a receiving ramp positioned opposite to the mating face, the receiving ramp continuously sloping further away from the mating face between a ramp first end and a ramp second end;
an elastically deflectable wedge body engageable with the receiving element in an installed condition, the wedge body including:
an engagement surface slidingly received by the receiving ramp in the installed condition;
a second surface opposed to the engagement surface, the second surface oriented at an angle with respect to the engagement surface; and
opposed ends integrally joining the engagement surface to the second surface.

22. The resilient wedge system of claim 21, wherein the engagement surface and the second surface are elastically deflectable toward each other.

23. The resilient wedge system of claim 21, wherein the body further comprises a first extending portion directed inwardly from the engagement surface.

24. The resilient wedge system of claim 23, wherein the body further comprises a second extending portion directed inwardly from the second surface and toward the first extending portion.

25. The resilient wedge system of claim 24, wherein the first and second extending portions oppose each other and operably define opposed internal cavities of the body, the internal cavities being interconnected by a passageway positioned between the first and second extending portions, the passageway being narrower than the internal cavities.

26. The resilient wedge system of claim 21, wherein the receiving element further comprises a plurality of substantially parallel raised ribs each extending substantially perpendicular to a longitudinal axis of the receiving ramp.

27. The resilient wedge system of claim 21, wherein the body further comprises an engagement member extending outwardly from a first one of the opposed ends.

28. The resilient wedge system of claim 27, wherein the body further comprises opposed flanges operable to resist release of the body from the installed condition.

29. A vehicle door resilient wedge system, comprising:
an elastically deflectable body including:
an engagement surface having a first extending portion directed inwardly with respect to the body from the engagement surface;
a second surface opposed to the engagement surface, the second surface oriented at an angle with respect to the engagement surface, the second surface including a second extending portion directed inwardly from the second surface and toward the first extending portion;
opposed first and second partial cavity pairs created in the first extending portion; and
opposed ends integrally joining the engagement surface to the second surface;
wherein each of the first and second extending portions includes an internal cavity, the internal cavities being interconnected by a passageway positioned between the first and second extending portions, the passageway being narrower than the internal cavities to permit elastic deflection of the first extending portion toward the second extending portion.

30. The system of claim 29, further comprising:
a first through aperture communicably joining the first partial cavity pair; and
a second through aperture communicably joining the second partial cavity pair.

31. The system of claim 30, further comprising opposed third and fourth partial cavity pairs created in the second extending portion.

32. The system of claim 31, further comprising:
a third through aperture communicably joining the third partial cavity pair; and
a fourth through aperture communicably joining the fourth partial cavity pair.
